(19) United States
(12) Patent Application Publication
(10) Pub. No.: US 2025/0317965 A1
(43) Pub. Date: Oct. 9, 2025

(54) COMMUNICATIONS USING MULTIPLE TRANSMISSION OPPORTUNITIES IN MULTIPLE LISTEN-BEFORE-TALK (LBT) SUB-BANDS

(71) Applicant: QUALCOMM Incorporated, San Diego, CA (US)

(72) Inventors: Shaozhen GUO, Beijing (CN); Changlong XU, Beijing (CN); Chih-Hao LIU, San Diego, CA (US); Jing SUN, San Diego, CA (US); Xiaoxia ZHANG, San Diego, CA (US); Luanxia YANG, Beijing (CN); Siyi CHEN, Beijing (CN); Hao XU, Beijing (CN)

(21) Appl. No.: 18/865,489

(22) PCT Filed: Jul. 27, 2022
(86) PCT No.: PCT/CN2022/108200

§ 371 Date: Nov. 13, 2024

(51) Int. Cl. H04W 74/0808; H04W 92/18

(52) U.S. Cl. CPC H04W 74/0808; H04W 92/18

(57) ABSTRACT

Various aspects of the present disclosure generally relate to wireless communication. In some aspects, a user equipment (UE) may perform listen-before-talk (LBT) for a plurality of transmission opportunities that are associated with different LBT sub-bands and that share a slot. The UE may transmit at least one sidelink communication using at least one of the plurality of transmission opportunities based at least in part on a result of performing the LBT. Numerous other aspects are described.

### FIELD OF THE DISCLOSURE

Aspects of the present disclosure generally relate to wireless communication and to techniques and apparatuses for communications using multiple transmission opportunities in multiple listen-before-talk (LBT) sub-bands.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a UE for wireless communication. The UE may include a memory and one or more processors coupled to the memory. The one or more processors may be configured to perform LBT for a plurality of transmission opportunities that are associated with different LBT sub-bands and that share a slot. The one or more processors may be configured to transmit at least one sidelink communication using at least one of the plurality of transmission opportunities based at least in part on a result of performing the LBT.

Some aspects described herein relate to a method of wireless communication performed by a UE. The method may include performing LBT for a plurality of transmission opportunities that are associated with different LBT sub-bands and that share a slot. The method may include transmitting at least one sidelink communication using at least one of the plurality of transmission opportunities based at least in part on a result of performing the LBT.

Some aspects described herein relate to a non-transitory computer-readable medium that stores a set of instructions for wireless communication by a UE. The set of instructions, when executed by one or more processors of the UE, may cause the UE to perform LBT for a plurality of transmission opportunities that are associated with different LBT sub-bands and that share a slot. The set of instructions, when executed by one or more processors of the UE, may cause the UE to transmit at least one sidelink using at least one of the plurality of transmission opportunities based at least in part on a result of performing the LBT.

Some aspects described herein relate to an apparatus for wireless communication. The apparatus may include means for performing LBT for a plurality of transmission opportunities that are associated with different LBT sub-bands and that share a slot. The apparatus may include means for transmitting at least one sidelink communication using at least one of the plurality of transmission opportunities based at least in part on a result of performing the LBT.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating examples of autonomous sensing, in accordance with the present disclosure.

FIG. 6 is a diagram illustrating an example associated with sidelink communications using multiple transmission opportunities in multiple LBT sub-bands, in accordance with the present disclosure.

FIG. 7 is a diagram illustrating examples associated with transmission of a single sidelink communication on one or more LBT sub-bands, in accordance with the present disclosure.

FIG. 8 is a diagram illustrating examples associated with transmission and retransmission of at least one sidelink communication on one or more LBT sub-bands, in accordance with the present disclosure.

FIG. 9 is a diagram illustrating examples associated with transmission and retransmission of multiple sidelink communications on multiple LBT sub-bands, in accordance with the present disclosure.

FIG. 10 is a diagram illustrating an example process performed, for example, by a UE, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

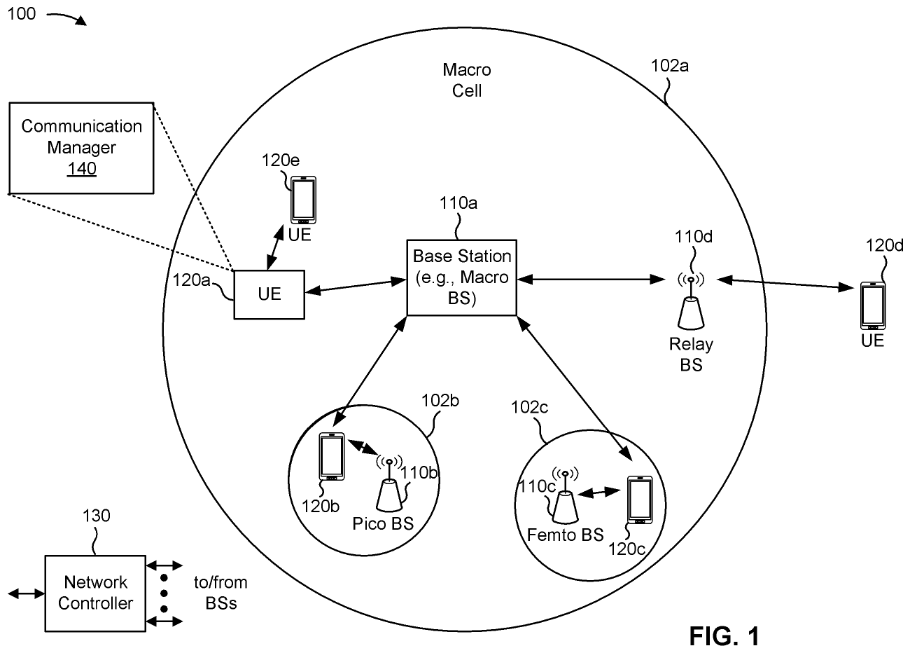

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may perform LBT for a plurality of transmission opportunities that are associated with different LBT sub-bands and that share a slot; and transmit at least one sidelink communication using at least one of the plurality of transmission opportunities based at least in part on a result of performing the LBT. Additionally, or alternatively, the communication manager 140 may perform one or more other operations described herein.

As indicated above, FIG. 1 is provided as an example. Other examples may differ from what is described with regard to FIG. 1.

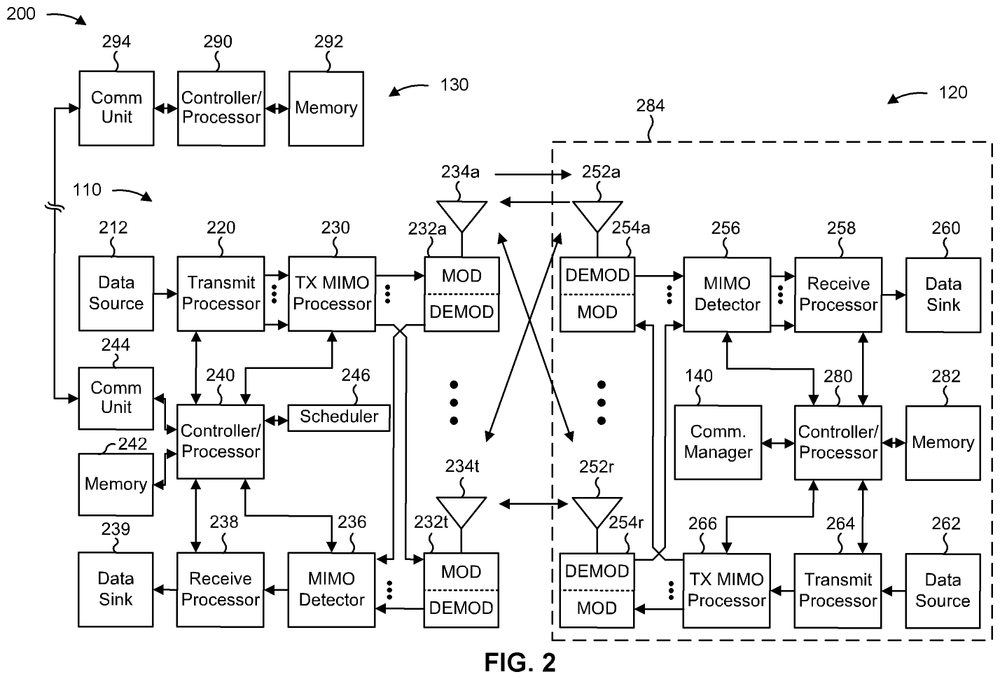

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

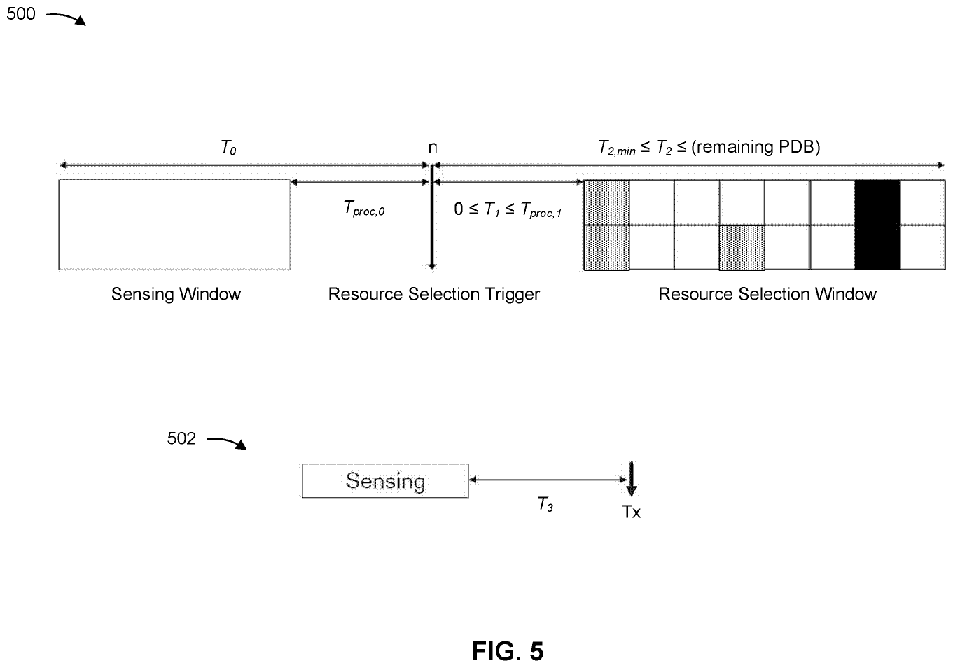

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-11).

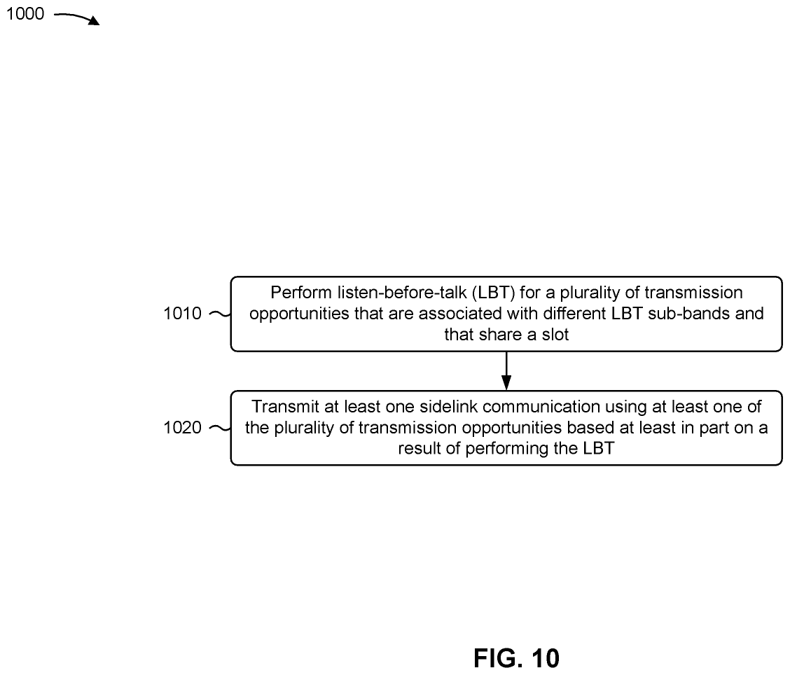

The controller/processor 240 of the network node 110, the controller/processor 280 of the UE 120, and/or any other component(s) of FIG. 2 may perform one or more techniques associated with communications using multiple transmission opportunities in multiple LBT sub-bands, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10. In some examples, executing instructions may include running the instructions, converting the instructions, compiling the instructions, and/or interpreting the instructions, among other examples.

In some aspects, a UE (e.g., the UE 120) includes means for performing LBT for a plurality of transmission opportunities that are associated with different LBT sub-bands and that share a slot; and/or means for transmitting at least one sidelink communication using at least one of the plurality of transmission opportunities based at least in part on a result of performing the LBT. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

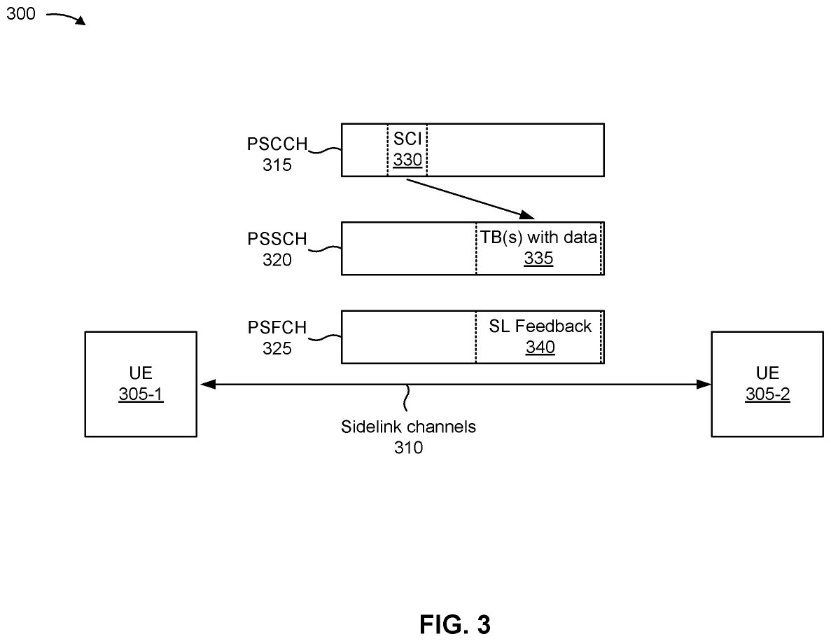

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 320, such as a hybrid automatic repeat request (HARQ) process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a network node 110 (e.g., a base station, a CU, or a DU). For example, the UE 305 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 305 may operate using a transmission mode (e.g., Mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or a modulation and coding scheme (MCS) to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

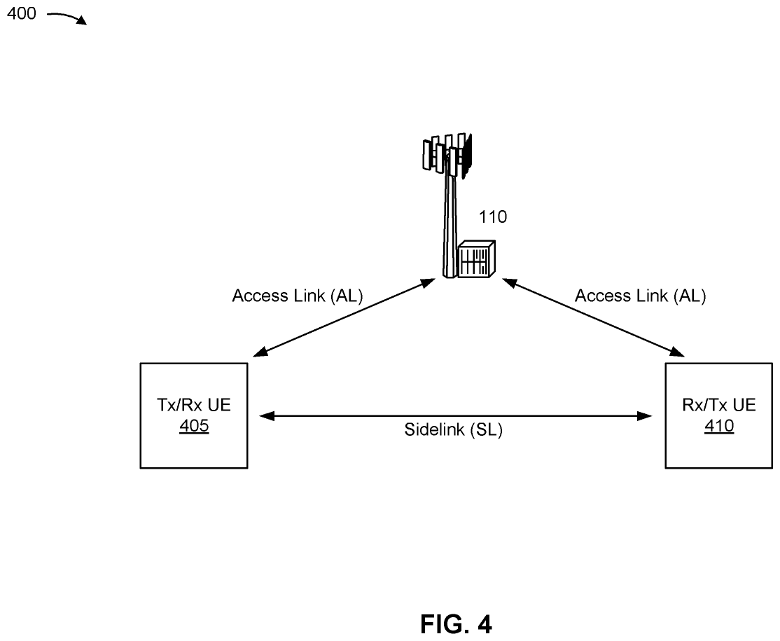

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a network node 110 may communicate with the Tx/Rx UE 405 (e.g., directly or via one or more network nodes), such as via a first access link. Additionally, or alternatively, in some sidelink modes, the network node 110 may communicate with the Rx/Tx UE 410 (e.g., directly or via one or more network nodes), such as via a first access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a network node 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 4 is provided as an example. Other examples may differ from what is described with respect to FIG. 4.

FIG. 5 is a diagram illustrating examples 500, 502 of autonomous sensing, in accordance with the present disclosure. Example 500 shows a timeline of a sensing window for sensing subchannels up to a resource selection trigger at time n for starting selection of resources inside a resource selection window. A beginning of the sensing window up to time n includes a time duration T₀. There are two time durations T_{proc,0} and T₁ that allow for processing. A time T₂ for resource selection follows time n, and a length of T₂ may depend on a remaining packet delay budget (PDB).

When a resource selection is triggered at time n, a physical (PHY) layer of a UE examines the sensing window to determine a set of candidate resources for the upcoming resource selection window. The PHY layer may report the set of candidate resources to a medium access control (MAC) layer of the UE. The MAC layer may randomly select a transmit resource from the set of candidate resources for transmitting a transport block (e.g., MAC protocol data unit). The MAC layer may also randomly select (or reserve) later transmit resources for HARQ retransmissions of the transport block, one at a time, on one or more PSSCHs.

Mode 2 sidelink transmission may involve continuously sensing a channel up to a specified minimum time T₃ before actual transmission of a transport block on a selected transmit resource. This may include at least a second sensing of a transmit resource, and the second sensing may be referred to as a “last-minute” reevaluation of the transmit resource. A UE (MAC layer) may request a PHY layer to update candidate resources at this time, to double check whether a coming transmit resource and other reserved transmit resources are still clear. The PHY layer may respond to the MAC layer with a set of candidate resources that are available (still clear). If the coming transmit resource is no longer clear, the PHY layer may set a reselection flag for the MAC layer, which may reselect a transmit resource from among the newly provided candidate resources. This may lead to a new T₃ based reevaluation. Otherwise, the PHY layer expects to transmit the transport block on the selected transmit resource.

NR sidelink may be used for various applications, such as V2X peer-to-peer safety messages. As noted herein, NR sidelink may involve two channel access modes. Mode 1 may be for deployment within coverage of a base station (e.g., gNB), where a sidelink transmitter (e.g., UE) receives grants from the gNB for sidelink channel access. Mode 2 may be for autonomous deployment, where a sidelink transmitter uses channel sensing to access a sidelink channel and communicate with other UEs. A sidelink transmitter may, for example, transmit SCI for transmitting a transport block on one or two PSSCHs. A transmit resource, which may include a subchannel in a slot (e.g., symbol, frame slot) may be reserved for transmitting the transport block. Reserving the resource may involve autonomous sensing, or sensing as determined by the UE.

As indicated above, FIG. 5 provides some examples. Other examples may differ from what is described with regard to FIG. 5.

As described herein, sidelink channels may be scheduled by a Tx UE without base station involvement (e.g., according to Mode 2 PC5 as defined in 3GPP specifications and/or another standard). Accordingly, the Tx UE may transmit SCI to reserve one or more resources and/or schedule transmissions for the sidelink channel. The Tx UE may transmit to a single Rx UE (e.g., using a unicast link on the sidelink channel), to a plurality of Rx UEs (e.g., using a groupcast link, also referred to as a multicast link, on the sidelink channel), and/or to any Rx UEs within a geographic area (e.g., by broadcasting on the sidelink channel).

In both Mode 1 and Mode 2, a Tx UE may use an LBT procedure on at least one sidelink channel. For example, the Tx UE may wait for one or more symbols of a slot (e.g., a portion of a radio frame), and transmit (e.g., to an Rx UE) within that slot only when the Tx UE does not decode a transmission in those one or more symbols. The Tx UE may wait for a preconfigured amount of time or for a dynamic amount of time (e.g., determined based on a minimum amount of time, a maximum amount of time, an energy level associated with the transmission, a power class of the Tx UE, an antenna gain associated with the Rx UE, and/or another variable). Accordingly, the LBT procedure may include a carrier sensing multiple access (CSMA) procedure, a clear channel assessment (CCA) procedure, a carrier sensing adaptive transmission (CSAT) procedure, and/or another similar procedure. For example, the Tx UE may use an LBT procedure as set forth in the Institute of Electrical and Electronics Engineers (IEEE) LAN/MAN Standards Committee 802.11 standards, the IEEE Wireless Coexistence Technical Advisory Group (TAG) 802.19 standards, the European Telecommunications Standards Institute (ETSI) Harmonised European Standard (EN) 300 328, and/or another standard. The Tx UE may use the LBT procedure at least in part because the at least one sidelink channel is over an unlicensed band channel. For example, the at least one sidelink channel may use NR unlicensed (NR-U) spectrum.

While LBT may be used for sidelink transmissions, an LBT failure (e.g., the Tx UE determines the sidelink channel is not clear for a transmission opportunity) may cause the Tx UE to skip a transmission for which LBT was performed. In a situation where a Mode 2 sidelink Tx UE may have reserved multiple resources for multiple sidelink transmissions, an LBT failure in one transmission may cause problems for future sidelink transmissions. For example, in a situation where LBT fails and a first sidelink transmission, which schedules/reserves future sidelink communications and/or retransmissions, is not transmitted, a collision (e.g., interference) may occur when the Tx UE attempts one of the future sidelink communications.

Some techniques and apparatuses described herein enable sidelink communications using multiple transmission opportunities in multiple LBT sub-bands. For example, after Mode 2 resource selection identifies potential transmission opportunities, a UE may perform LBT for the transmission opportunities that are associated with different LBT sub-bands and that share a same slot. Based on a result of the LBT, the UE may transmit one or more sidelink communications using at least one of the transmission opportunities. In this way, the likelihood of successfully transmitting sidelink communications may increase and the potential for collisions and/or interference may decrease, relative to sidelink communication schemes that use LBT without using the multiple sub-band techniques described herein. In addition, various implementations may increase throughput and/or reduce latency by providing additional transmission opportunities that may be used to transmit to multiple UEs and/or to transmit different transport blocks to the same or different UEs.

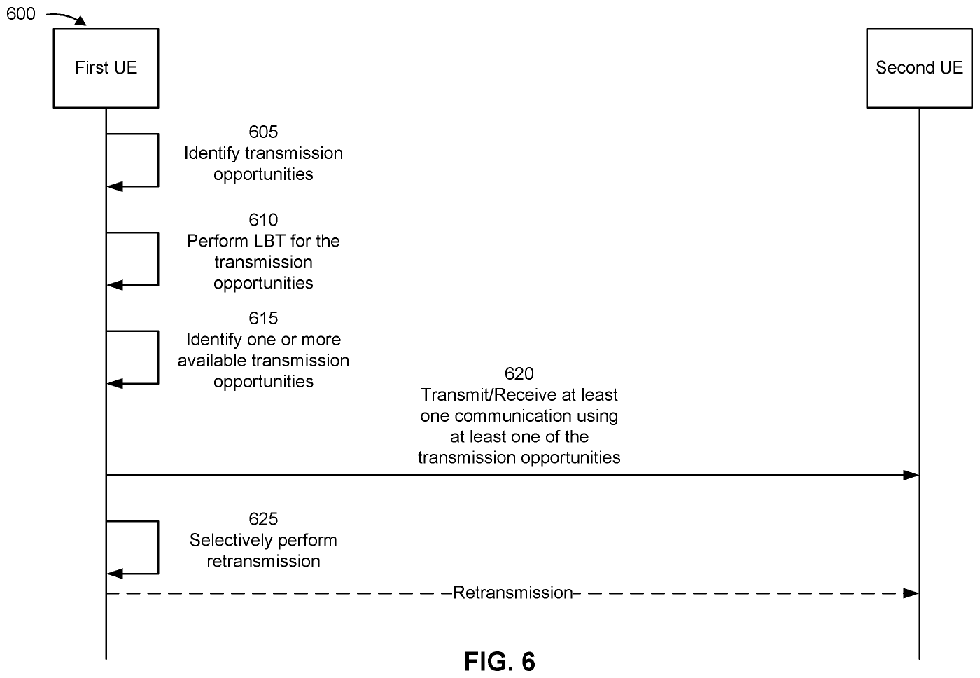

FIG. 6 is a diagram illustrating an example 600 associated with sidelink communications using multiple transmission opportunities in multiple LBT sub-bands, in accordance with the present disclosure. As shown in FIG. 6, a first UE (e.g., UE 120) and a second UE (e.g., UE 120) may communicate with one another. For example, the first UE and second UE may communicate with one another via sidelink. As used herein, “sidelink communication” may refer to a combined PSCCH and PSSCH transmission, which may occur within one or more transmission opportunities. A sidelink communication transmitted on different transmission opportunities may be the same in both transmission opportunities, but may have different characteristics (e.g., different redundancy versions) while including the same information (e.g., the same transport block, the same PSCCH and PSSCH information, and/or the like).

As shown by reference number 605, the first UE may identify transmission opportunities. In some aspects, the first UE may identify the transmission opportunities based at least in part on a Mode 2 sidelink resource selection process, such as a resource selection process described herein. For example, the first UE may perform a sensing operation to identify resources to exclude from consideration for sidelink communications (e.g., due to channel conditions, interference, and/or the like) and identify other resources (e.g., via random selection or another selection technique) as transmission opportunities for the first UE. In some aspects, the identified transmission opportunities may span a period of time, such that the first UE reserves resources for a particular slot as well as future slots after the particular slot.

As shown by reference number 610, the first UE may perform LBT for the transmission opportunities. In some aspects, the first UE may perform LBT for different transmission opportunities that share the same slot but are in different LBT sub-bands. If LBT passes for a transmission opportunity, that transmission opportunity may be identified as available. If LBT fails, the corresponding transmission opportunity may be unavailable. LBT may be performed, as described herein, to enable the first UE to determine which transmission opportunities will be available for use in sidelink communications (e.g., with another UE, such as the second UE).

As shown by reference number 615, the first UE may identify one or more available transmission opportunities based at least in part on a result of performing LBT. For example, the results of LBT (e.g., pass or fail) may indicate which transmission opportunities are available, and the first UE may identify which of the one or more available transmission opportunities to use based at least in part on the results. In other words, in a situation where LBT passes for one or more transmission opportunities, the first UE may have multiple ways to transmit one or more sidelink communications. The first UE may select, from the available transmission opportunities, which transmission opportunity or opportunities are to be used to communicate with another UE.

In some aspects, the result of LBT may indicate that only one transmission opportunity is available. In this situation, the UE may identify the one available transmission opportunity for use in transmitting a sidelink communication.

In some aspects, the result of LBT may indicate that multiple transmission opportunities are available. In this situation, the first UE may identify all available transmission opportunities, one of the available transmission opportunities, or a subset of all available transmission opportunities (e.g., less than all available transmission opportunities). In a situation where the first UE identifies less than all of the available transmission opportunities, the UE may identify which of the available transmission opportunities should be used in a variety of ways.

In some aspects, the first UE may identify, from multiple available transmission opportunities, one or more transmission opportunities by random selection (e.g., including pseudo-random selection techniques). For example, in a situation where two transmission opportunities are available, the first UE may randomly choose which transmission opportunity is to be used for communicating with another UE.

In some aspects, the first UE may identify a transmission opportunity, from multiple available transmission opportunities, based at least in part on a preconfigured indication of a primary transmission opportunity. For example, the first UE may be preconfigured to favor using one or more particular transmission opportunities, when available. For example, the first UE may be preconfigured to select a transmission opportunity from a particular sub-band if a transmission opportunity within that sub-band is available.

In some aspects, the first UE may identify, from multiple available transmission opportunities, one or more transmission opportunities based at least in part on measures of priority associated with the available transmission opportunities. For example, the measures of priority may be based at least in part on one or more measures of energy detected when performing the LBT (e.g., lower energy measurements being associated with a higher priority than higher energy measurements), and/or one or more received signal strength indicator (RSSI) measurements obtained during resource sensing (e.g., lower RSSI measurements being associated with higher priority than higher RSSI measurements), among other example measurements associated with evaluating channel conditions.

As shown by reference number 620, the first UE may transmit, and the second UE may receive, at least one sidelink communication using at least one of the identified transmission opportunities. The transmission may use the transmission occasions identified by the first UE, as described herein. In some aspects, the first UE may transmit one sidelink communication using one or multiple transmission opportunities. Additionally, or alternatively, the first UE may transmit multiple sidelink communications using one or multiple transmission opportunities. In some situations, the first UE may also use one or more transmission opportunities for retransmissions.

For example, in some aspects, the first UE may transmit a single sidelink communication using a single transmission opportunity. For example, the first UE may transmit a sidelink communication, including PSCCH and PSSCH transmissions, in one transmission opportunity. In a situation where retransmission is selected, SCI included in the single sidelink communication (e.g., in the PSCCH) may indicate one or more resources for retransmission of the single sidelink communication. The one or more resources for retransmission may be in the same LBT sub-band or different LBT sub-bands from each other and/or the single transmission opportunity.

In some aspects, the first UE may transmit a single sidelink communication using multiple transmission opportunities. For example, the first UE may repeat a sidelink communication, including PSCCH and PSSCH transmissions, in multiple transmission opportunities. In some aspects, the SCI of each PSCCH may indicate the same resources for retransmission. In this situation, if retransmission is to occur (e.g., based at least in part on HARQ feedback received, or not received, by the first UE), the resources to be used for retransmission are the same for each SCI. In some aspects, when transmitting using multiple transmission opportunities, the first UE may split transmission power equally between the transmission opportunities for PSSCH transmissions. Additionally, or alternatively, the first UE may use the same or different redundancy versions for PSSCH in multiple transmission opportunities.

In some aspects, the first UE may transmit multiple sidelink communications using multiple transmission opportunities. For example, the first UE may transmit multiple sidelink communications, each including PSCCH and PSSCH transmissions, in multiple transmission opportunities. In some aspects, the SCI of each PSCCH may indicate different resources for retransmission. In this situation, if retransmission is to occur, the resources to be used for retransmission are different for each SCI. For example, first SCI, included in a first sidelink communication of the multiple sidelink communications, may indicate one or more first resources for retransmission of the first sidelink communication in a first LBT sub-band. Second SCI, included in a second sidelink communication of the multiple sidelink communications, may indicate one or more second resources for retransmission of the second sidelink communication in a second LBT sub-band.

In some aspects, when the first UE is transmitting multiple sidelink communications (e.g., using multiple transmission opportunities that share a slot), the multiple sidelink communications may include the same transport block (e.g., with different SCI) or different transport blocks (e.g., also with different SCI). When transmitting multiple sidelink communications with different transport blocks using multiple transmission opportunities in the same slot, the first UE may communicate with multiple other UEs (e.g., the second UE and a third UE). In this situation, retransmission may be reserved for each sidelink communication separately (e.g., retransmission of a sidelink communication may use only resources reserved by the corresponding SCI that schedules the sidelink communication).

As shown by reference number 625, the first UE may selectively perform retransmission of one or more sidelink communications. For example, the first UE may perform retransmission as described herein. In some aspects, when multiple sidelink communications with different transport blocks are transmitted using multiple transmission opportunities, selectively performing retransmission may include retransmitting a first sidelink communication using the resources that were indicated for retransmission of the second sidelink communication, and/or retransmitting the second sidelink communication using resources that were indicated for retransmission of the first sidelink communication. For example, rather than having retransmission opportunities reserved separately for multiple different sidelink communications with different transport blocks, the first UE may use any resources reserved for retransmission of any sidelink communication for retransmission of any other sidelink communication. In this situation, the multiple different sidelink communications may be transmitted to the same UE, and the first UE may indicate a HARQ process number in SCI of the retransmission to indicate which sidelink communication is being retransmitted.

By evaluating and/or using multiple transmission occasions across multiple LBT sub-bands for sidelink communications, the likelihood of successfully transmitting sidelink communications may increase and the potential for collisions and/or interference may decrease, relative to sidelink communication schemes that use LBT without using the multiple sub-band techniques described herein. In addition, various implementations may increase throughput and/or reduce latency by providing additional transmission opportunities that may be used to transmit to multiple UEs and/or to transmit different transport blocks to the same or different UEs.

As indicated above, FIG. 6 is provided as an example. Other examples may differ from what is described with respect to FIG. 6. For example, different combinations of one or multiple sidelink communications, with the same or different SCI, on the same or different transmission opportunities, may be used by the first UE for communicating with one or more other UEs via sidelink.

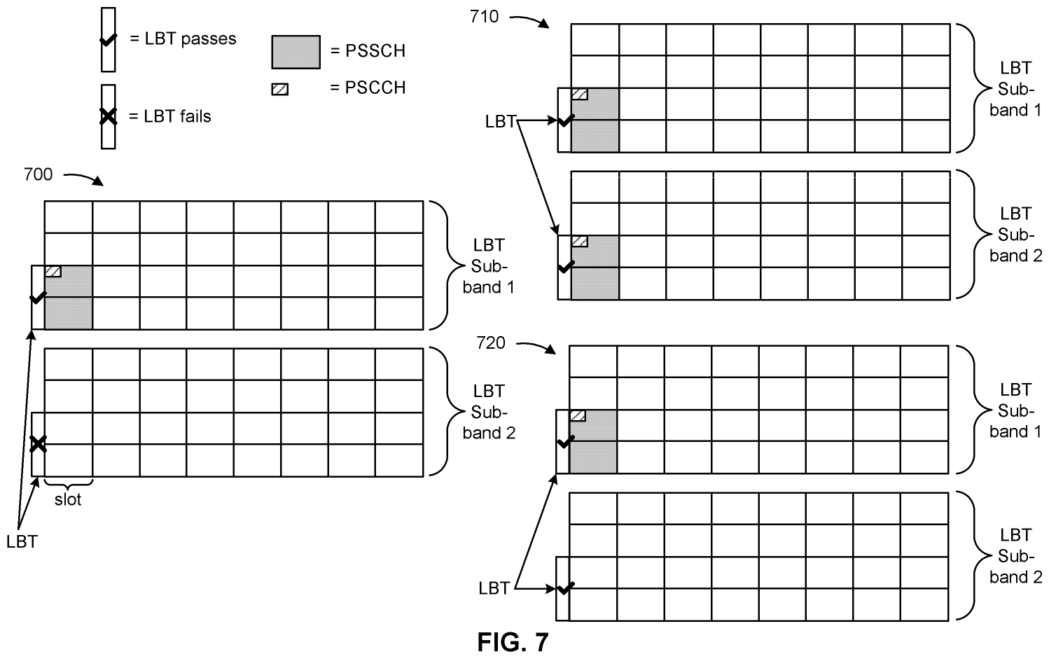

FIG. 7 is a diagram illustrating examples 700, 710, and 720 associated with transmission of a single sidelink communication on one or more LBT sub-bands, in accordance with the present disclosure. As shown in FIG. 7, a UE may transmit a sidelink communication using one or more transmission opportunities based at least in part on a result of performing LBT.

As shown by reference number 700, LBT passed in a first LBT sub-band but failed in the second LBT sub-band. Accordingly, the UE may transmit a sidelink communication in the first LBT sub-band.

As shown by reference number 710, LBT passed for both the first and second LBT sub-bands. In this example, the UE transmits the sidelink communication in both LBT sub-bands.

As shown by reference number 720, LBT passed for both the first and second LBT sub-bands. In this example, the UE transmits the sidelink communication in one of the LBT sub-bands, but not the other. The UE may determine which LBT sub-band is used (e.g., which transmission opportunity is used), as described herein (e.g., random selection, selection based on pre-configuration, selection based on priority, and/or the like).

As indicated above, FIG. 7 is provided as an example. Other examples may differ from what is described with respect to FIG. 7.

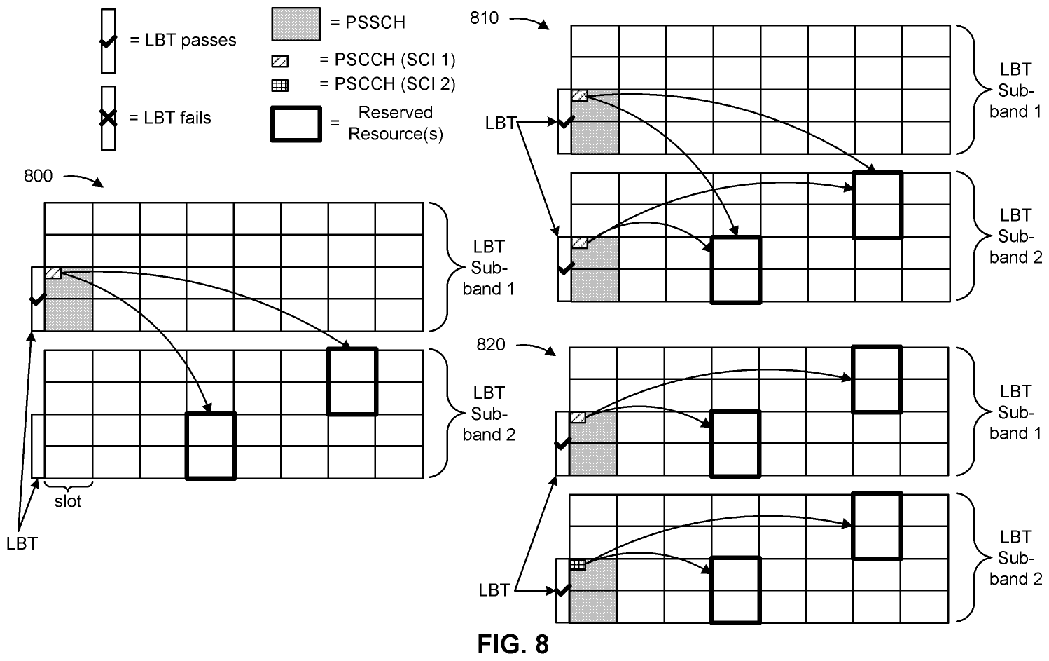

FIG. 8 is a diagram illustrating examples 800, 810, and 820 associated with transmission and retransmission of at least one sidelink communication on one or more LBT sub-bands, in accordance with the present disclosure. As shown in FIG. 8, a UE may transmit at least one sidelink communication using one or more transmission opportunities, including retransmission scheduling information, based at least in part on a result of performing LBT.

As shown by reference number 800, LBT passed for at least one LBT sub-band (e.g., the first LBT sub-band). In this example, the UE transmits a sidelink communication in the first LBT sub-band and also indicates resources for retransmission of the sidelink communication. While the resources for retransmission are indicated in a different LBT sub-band than the LBT sub-band in which the sidelink communication was transmitted, the retransmissions may be reserved and/or scheduled in either (or both) LBT sub-bands.

As shown by reference number 810, LBT passed for both the first and second LBT sub-bands. In this example, the UE transmits the same sidelink communication (e.g., the same transport block, the same PSCCH and PSSCH transmissions, and/or the like) in both LBT sub-bands, and the SCI transmitted in each transmission opportunity specifies the same resources for retransmission of the sidelink communication. In other words, whether a recipient UE receives the sidelink communication in the first or second LBT sub-band, retransmission is reserved/scheduled for the second LBT sub-band, in this example. As described herein, the retransmissions may be reserved and/or scheduled in either (or both) LBT sub-bands.

As shown by reference number 820, LBT passed for both the first and second LBT sub-bands. In this example, the UE transmits different sidelink communications (e.g., different SCI, in this example) in different LBT sub-bands. The different SCI indicates separate LBT sub-bands for retransmission of each sidelink communication separately, in this example, such that a first sidelink communication in the first LBT sub-band is scheduled for retransmission in the first LBT sub-band, and the second sidelink communication in the second LBT sub-band is scheduled for retransmission in the second LBT sub-band.

As indicated above, FIG. 8 is provided as an example. Other examples may differ from what is described with respect to FIG. 8.

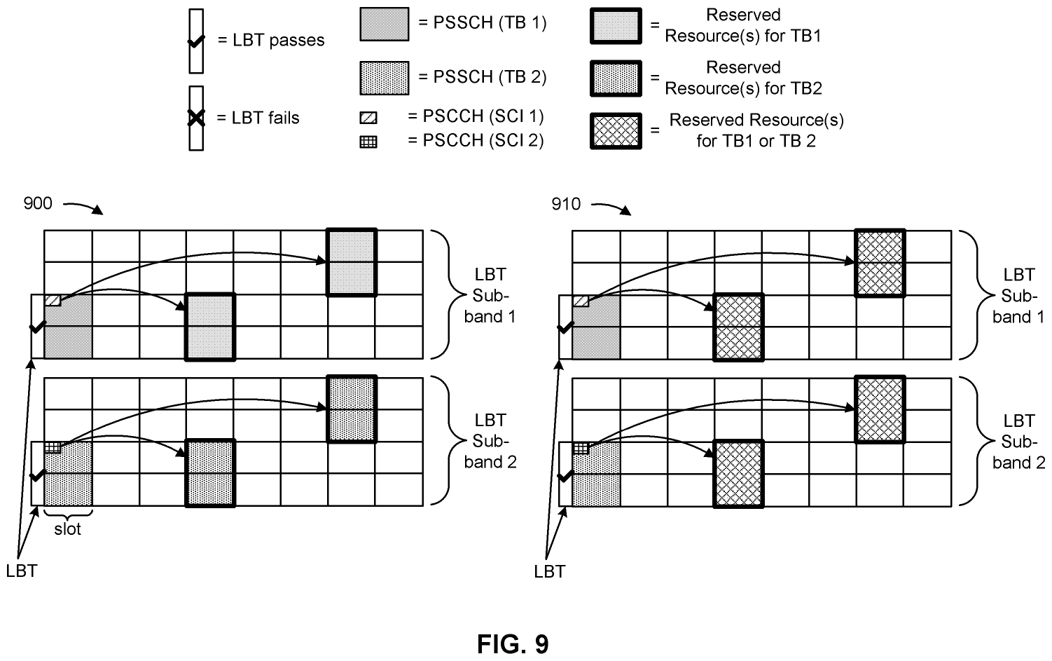

FIG. 9 is a diagram illustrating examples 900 and 910 associated with transmission and retransmission of multiple sidelink communications on multiple LBT sub-bands, in accordance with the present disclosure. As shown in FIG. 9, a UE may transmit multiple sidelink communications using multiple transmission opportunities, including retransmission scheduling information, based at least in part on a result of performing LBT.

As shown by reference number 900, LBT passed for both the first and second LBT sub-bands. In this example, the UE transmits different sidelink communications (e.g., different SCI and different transport blocks, in this example) in different LBT sub-bands. The different SCI indicates separate reserved resources or LBT sub-bands for retransmission of each sidelink communication separately, in this example, such that a first sidelink communication in the first LBT sub-band is scheduled for retransmission in the first LBT sub-band, and the second sidelink communication in the second LBT sub-band is scheduled for retransmission in the second LBT sub-band.

As shown by reference number 910, LBT passed for both the first and second LBT sub-bands. In this example, the UE transmits different sidelink communications (e.g., different SCI and different transport blocks, in this example) in different LBT sub-bands. The different SCI indicates, in this example, that retransmission may occur in either LBT sub-band, such that either sidelink communication may be retransmitted in either the first LBT sub-band or the second LBT sub-band. In this example, the reserved resources indicated by a first SCI can be used for retransmission of the sidelink communication scheduled by a second SCI, and the reserved resources indicated by the second SCI can be used for retransmission of the sidelink communication scheduled by the first SCI.

As indicated above, FIG. 9 is provided as an example. Other examples may differ from what is described with respect to FIG. 9.

FIG. 10 is a diagram illustrating an example process 1000 performed, for example, by a UE, in accordance with the present disclosure. Example process 1000 is an example where the UE (e.g., UE 120) performs operations associated with sidelink communications using multiple transmission opportunities in multiple LBT sub-bands.

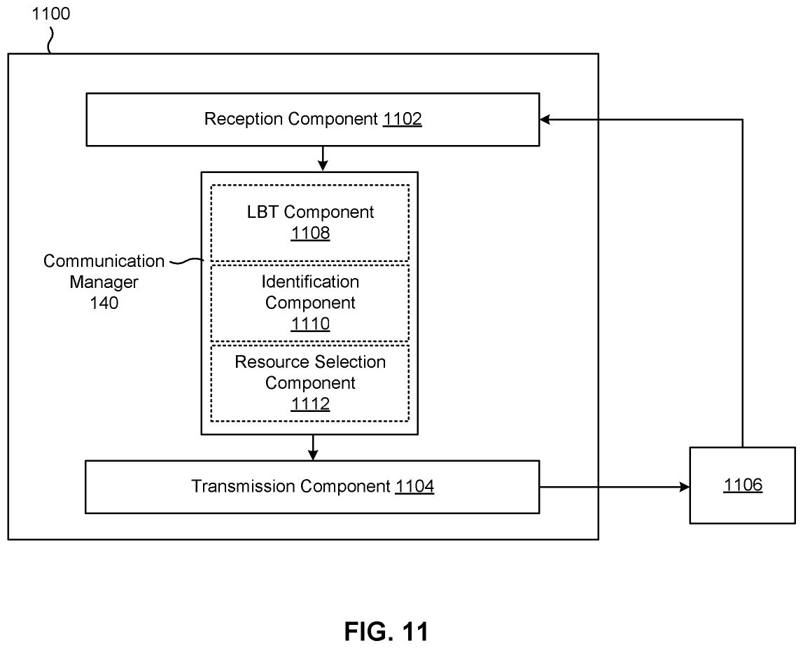

As shown in FIG. 10, in some aspects, process 1000 may include performing LBT for a plurality of transmission opportunities that are associated with different LBT sub-bands and that share a slot (block 1010). For example, the UE (e.g., using communication manager 140 and/or LBT component 1108, depicted in FIG. 11) may perform LBT for a plurality of transmission opportunities that are associated with different LBT sub-bands and that share a slot, as described above.

As further shown in FIG. 10, in some aspects, process 1000 may include transmitting at least one sidelink communication using at least one of the plurality of transmission opportunities based at least in part on a result of performing the LBT (block 1020). For example, the UE (e.g., using communication manager 140 and/or transmission component 1104, depicted in FIG. 11) may transmit at least one sidelink communication using at least one of the plurality of transmission opportunities based at least in part on a result of performing the LBT, as described above. Process 1000 may include additional aspects, such as any single aspect or any combination of aspects described below and/or in connection with one or more other processes described elsewhere herein.

In a first aspect, the result of performing the LBT indicates that only one available transmission opportunity from the plurality of transmission opportunities, and wherein transmitting the sidelink communication comprises transmitting the sidelink communication using the one available transmission opportunity.

In a second aspect, alone or in combination with the first aspect, the result of performing the LBT indicates multiple available transmission opportunities from the plurality of transmission opportunities.

In a third aspect, alone or in combination with one or more of the first and second aspects, transmitting the sidelink communication comprises transmitting the sidelink communication using all of the multiple available transmission opportunities.

In a fourth aspect, alone or in combination with one or more of the first through third aspects, transmitting the sidelink communication comprises transmitting the sidelink communication using a single transmission opportunity of the multiple available transmission opportunities.

In a fifth aspect, alone or in combination with one or more of the first through fourth aspects, process 1000 includes identifying, from the multiple available transmission opportunities, the single transmission opportunity by random selection.

In a sixth aspect, alone or in combination with one or more of the first through fifth aspects, process 1000 includes identifying, from the multiple available transmission opportunities, the single transmission opportunity based at least in part on a preconfigured indication of a primary transmission opportunity.

In a seventh aspect, alone or in combination with one or more of the first through sixth aspects, process 1000 includes identifying, from the multiple available transmission opportunities, the single transmission opportunity based at least in part on measures of priority associated with the multiple available transmission opportunities.

In an eighth aspect, alone or in combination with one or more of the first through seventh aspects, the measures of priority are based at least in part on one or more of one or more measures of energy detected when performing the LBT, or one or more received signal strength indicator measurements obtained during resource sensing.

In a ninth aspect, alone or in combination with one or more of the first through eighth aspects, transmitting the at least one sidelink communication using at least one of the plurality of transmission opportunities comprises transmitting a single sidelink communication using a single transmission opportunity, wherein sidelink control information included in the single sidelink communication indicates one or more resources for retransmission of the single sidelink communication.

In a tenth aspect, alone or in combination with one or more of the first through ninth aspects, transmitting the at least one sidelink communication using at least one of the plurality of transmission opportunities comprises transmitting a single sidelink communication using multiple transmission opportunities, wherein a single transport block is repeated in each of the multiple transmission opportunities, and sidelink control information is repeated in each of the multiple transmission opportunities and indicates one or more resources for retransmission of the single transport block.

In an eleventh aspect, alone or in combination with one or more of the first through tenth aspects, transmitting the at least one sidelink communication using at least one of the plurality of transmission opportunities comprises transmitting multiple sidelink communications using multiple transmission opportunities, first sidelink control information, that schedules a first sidelink communication of the multiple sidelink communications, indicates one or more first resources for retransmission, and wherein second sidelink control information, that schedules a second sidelink communication of the multiple sidelink communications, indicates one or more second resources for retransmission.

In a twelfth aspect, alone or in combination with one or more of the first through eleventh aspects, the one or more first resources for retransmission are in a first LBT sub-band of the different LBT sub-bands and the one or more second resources for retransmission are in a second LBT sub-band of the different LBT sub-bands.

In a thirteenth aspect, alone or in combination with one or more of the first through twelfth aspects, the first sidelink communication includes a first transport block that is the same as a second transport block included in the second sidelink communication.

In a fourteenth aspect, alone or in combination with one or more of the first through thirteenth aspects, the first sidelink communication includes a first transport block that is different from a second transport block included in the second sidelink communication.

In a fifteenth aspect, alone or in combination with one or more of the first through fourteenth aspects, process 1000 includes selectively performing retransmission of at least one of the first sidelink communication or the second sidelink communication, selectively performing retransmission of the first sidelink communication comprises performing retransmission of the first sidelink communication using the one or more first resources that were indicated by the first sidelink control information, and selectively performing retransmission of the second sidelink communication comprises performing retransmission of the second sidelink communication using the one or more second resources that were indicated by the second sidelink control information.

In a sixteenth aspect, alone or in combination with one or more of the first through fifteenth aspects, process 1000 includes selectively performing retransmission of at least one of the first sidelink communication or the second sidelink communication, selectively performing retransmission of the first sidelink communication comprises performing retransmission of the first sidelink communication using at least one of the one or more first resources that were indicated by the first sidelink control information, or the one or more second resources that were indicated by the second sidelink control information, and selectively performing retransmission of the second sidelink communication comprises performing retransmission of the second sidelink communication using at least one of the one or more first resources that were indicated by the first sidelink control information, or the one or more second resources that were indicated by the second sidelink control information.

In a seventeenth aspect, alone or in combination with one or more of the first through sixteenth aspects, process 1000 includes identifying the plurality of transmission opportunities based at least in part on a mode 2 sidelink resource selection process.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include one or more of an LBT component 1108, an identification component 1110, or a resource selection component 1112, among other examples.

In some aspects, the apparatus 1100 may be configured to perform one or more operations described herein in connection with FIG. 3-9. Additionally, or alternatively, the apparatus 1100 may be configured to perform one or more processes described herein, such as process 1000 of FIG. 10. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The LBT component 1108 may perform listen-before-talk (LBT) for a plurality of transmission opportunities that are associated with different LBT sub-bands and that share a slot. The transmission component 1104 may transmit at least one sidelink communication using at least one of the plurality of transmission opportunities based at least in part on a result of performing the LBT.

The identification component 1110 may identify, from the multiple available transmission opportunities, the single transmission opportunity by random selection.

The identification component 1110 may identify, from the multiple available transmission opportunities, the single transmission opportunity based at least in part on a preconfigured indication of a primary transmission opportunity.

The identification component 1110 may identify, from the multiple available transmission opportunities, the single transmission opportunity based at least in part on measures of priority associated with the multiple available transmission opportunities.

The transmission component 1104 may selectively perform retransmission of at least one of the first sidelink communication or the second sidelink communication wherein selectively performing retransmission of the first sidelink communication comprises performing retransmission of the first sidelink communication using the one or more first resources that were indicated by the first sidelink control information, and wherein selectively performing retransmission of the second sidelink communication comprises performing retransmission of the second sidelink communication using the one or more second resources that were indicated by the second sidelink control information.

The transmission component 1104 may selectively perform retransmission of at least one of the first sidelink communication or the second sidelink communication wherein selectively performing retransmission of the first sidelink communication comprises performing retransmission of the first sidelink communication using at least one of the one or more first resources that were indicated by the first sidelink control information, or the one or more second resources that were indicated by the second sidelink control information, and wherein selectively performing retransmission of the second sidelink communication comprises performing retransmission of the second sidelink communication using at least one of the one or more first resources that were indicated by the first sidelink control information, or the one or more second resources that were indicated by the second sidelink control information.

The resource selection component 1112 may identify the plurality of transmission opportunities based at least in part on a mode 2 sidelink resource selection process.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: performing listen-before-talk (LBT) for a plurality of transmission opportunities that are associated with different LBT sub-bands and that share a slot; and transmitting at least one sidelink communication using at least one of the plurality of transmission opportunities based at least in part on a result of performing the LBT.

Aspect 2: The method of Aspect 1, wherein the result of performing the LBT indicates that only one available transmission opportunity from the plurality of transmission opportunities; and wherein transmitting the sidelink communication comprises: transmitting the sidelink communication using the one available transmission opportunity.

Aspect 3: The method of any of Aspects 1-2, wherein the result of performing the LBT indicates multiple available transmission opportunities from the plurality of transmission opportunities.

Aspect 4: The method of Aspect 3, wherein transmitting the sidelink communication comprises: transmitting the sidelink communication using all of the multiple available transmission opportunities.

Aspect 5: The method of Aspect 3, wherein transmitting the sidelink communication comprises: transmitting the sidelink communication using a single transmission opportunity of the multiple available transmission opportunities.

Aspect 6: The method of Aspect 5, further comprising: identifying, from the multiple available transmission opportunities, the single transmission opportunity by random selection.

Aspect 7: The method of Aspect 5, further comprising: identifying, from the multiple available transmission opportunities, the single transmission opportunity based at least in part on a preconfigured indication of a primary transmission opportunity.

Aspect 8: The method of Aspect 5, further comprising: identifying, from the multiple available transmission opportunities, the single transmission opportunity based at least in part on measures of priority associated with the multiple available transmission opportunities.

Aspect 9: The method of Aspect 8, wherein the measures of priority are based at least in part on one or more of: one or more measures of energy detected when performing the LBT, or one or more received signal strength indicator measurements obtained during resource sensing.

Aspect 10: The method of any of Aspects 1-9, wherein transmitting the at least one sidelink communication using at least one of the plurality of transmission opportunities comprises: transmitting a single sidelink communication using a single transmission opportunity, wherein sidelink control information included in the single sidelink communication indicates one or more resources for retransmission of the single sidelink communication.

Aspect 11: The method of any of Aspects 1-10, wherein transmitting the at least one sidelink communication using at least one of the plurality of transmission opportunities comprises: transmitting a single sidelink communication using multiple transmission opportunities, wherein a single transport block is repeated in each of the multiple transmission opportunities, and sidelink control information is repeated in each of the multiple transmission opportunities and indicates one or more resources for retransmission of the single transport block.

Aspect 12: The method of any of Aspects 1-11, wherein transmitting the at least one sidelink communication using at least one of the plurality of transmission opportunities comprises: transmitting multiple sidelink communications using multiple transmission opportunities, wherein first sidelink control information, that schedules a first sidelink communication of the multiple sidelink communications, indicates one or more first resources for retransmission, and wherein second sidelink control information, that schedules a second sidelink communication of the multiple sidelink communications, indicates one or more second resources for retransmission.

Aspect 13: The method of Aspect 12, wherein the one or more first resources for retransmission are in a first LBT sub-band of the different LBT sub-bands and the one or more second resources for retransmission are in a second LBT sub-band of the different LBT sub-bands.

Aspect 14: The method of Aspect 12, wherein the first sidelink communication includes a first transport block that is the same as a second transport block included in the second sidelink communication.

Aspect 15: The method of Aspect 12, wherein the first sidelink communication includes a first transport block that is different from a second transport block included in the second sidelink communication.

Aspect 16: The method of Aspect 15, further comprising: selectively performing retransmission of at least one of the first sidelink communication or the second sidelink communication, wherein selectively performing retransmission of the first sidelink communication comprises performing retransmission of the first sidelink communication using the one or more first resources that were indicated by the first sidelink control information, and wherein selectively performing retransmission of the second sidelink communication comprises performing retransmission of the second sidelink communication using the one or more second resources that were indicated by the second sidelink control information.

Aspect 17: The method of Aspect 15, further comprising: selectively performing retransmission of at least one of the first sidelink communication or the second sidelink communication, wherein selectively performing retransmission of the first sidelink communication comprises performing retransmission of the first sidelink communication using at least one of the one or more first resources that were indicated by the first sidelink control information, or the one or more second resources that were indicated by the second sidelink control information, and wherein selectively performing retransmission of the second sidelink communication comprises performing retransmission of the second sidelink communication using at least one of the one or more first resources that were indicated by the first sidelink control information, or the one or more second resources that were indicated by the second sidelink control information.

Aspect 18: The method of any of Aspects 1-17, further comprising: identifying the plurality of transmission opportunities based at least in part on a mode 2 sidelink resource selection process.

Aspect 19: An apparatus for wireless communication at a device, comprising a processor; memory coupled with the processor; and instructions stored in the memory and executable by the processor to cause the apparatus to perform the method of one or more of Aspects 1-18.

Aspect 20: A device for wireless communication, comprising a memory and one or more processors coupled to the memory, the one or more processors configured to perform the method of one or more of Aspects 1-18.

Aspect 21: An apparatus for wireless communication, comprising at least one means for performing the method of one or more of Aspects 1-18.

Aspect 22: A non-transitory computer-readable medium storing code for wireless communication, the code comprising instructions executable by a processor to perform the method of one or more of Aspects 1-18.

Aspect 23: A non-transitory computer-readable medium storing a set of instructions for wireless communication, the set of instructions comprising one or more instructions that, when executed by one or more processors of a device, cause the device to perform the method of one or more of Aspects 1-18.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
perform listen-before-talk (LBT) for a plurality of transmission opportunities that are associated with different LBT sub-bands and that share a slot; and
transmit at least one sidelink communication using at least one of the plurality of transmission opportunities based at least in part on a result of performing the LBT.

2. The UE of claim 1, wherein the result of performing the LBT indicates that only one available transmission opportunity from the plurality of transmission opportunities; and
wherein the one or more processors, to transmit the sidelink communication, are configured to:
transmit the sidelink communication using the one available transmission opportunity.

3. The UE of claim 1, wherein the result of performing the LBT indicates multiple available transmission opportunities from the plurality of transmission opportunities.

4. The UE of claim 3, wherein the one or more processors, to transmit the sidelink communication, are configured to:
transmit the sidelink communication using all of the multiple available transmission opportunities.

5. The UE of claim 3, wherein the one or more processors, to transmit the sidelink communication, are configured to:
transmit the sidelink communication using a single transmission opportunity of the multiple available transmission opportunities.

6. The UE of claim 5, wherein the one or more processors are further configured to:
identify, from the multiple available transmission opportunities, the single transmission opportunity by random selection.

7. The UE of claim 5, wherein the one or more processors are further configured to:
identify, from the multiple available transmission opportunities, the single transmission opportunity based at least in part on a preconfigured indication of a primary transmission opportunity.

8. The UE of claim 5, wherein the one or more processors are further configured to:
identify, from the multiple available transmission opportunities, the single transmission opportunity based at least in part on measures of priority associated with the multiple available transmission opportunities.

9. The UE of claim 8, wherein the measures of priority are based at least in part on one or more of:
one or more measures of energy detected when performing the LBT, or
one or more received signal strength indicator measurements obtained during resource sensing.

10. The UE of claim 1, wherein the one or more processors, to transmit the at least one sidelink communication using at least one of the plurality of transmission opportunities, are configured to:
transmit a single sidelink communication using a single transmission opportunity,
wherein sidelink control information included in the single sidelink communication indicates one or more resources for retransmission of the single sidelink communication.

11. The UE of claim 1, wherein the one or more processors, to transmit the at least one sidelink communication using at least one of the plurality of transmission opportunities, are configured to:
transmit a single sidelink communication using multiple transmission opportunities,
wherein a single transport block is repeated in each of the multiple transmission opportunities, and
sidelink control information is repeated in each of the multiple transmission opportunities and indicates one or more resources for retransmission of the single transport block.

12. The UE of claim 1, wherein the one or more processors, to transmit the at least one sidelink communication using at least one of the plurality of transmission opportunities, are configured to:
transmit multiple sidelink communications using multiple transmission opportunities,
wherein first sidelink control information, that schedules a first sidelink communication of the multiple sidelink communications, indicates one or more first resources for retransmission, and
wherein second sidelink control information, that schedules a second sidelink communication of the multiple sidelink communications, indicates one or more second resources for retransmission.

13. The UE of claim 12, wherein the one or more first resources for retransmission are in a first LBT sub-band of the different LBT sub-bands and the one or more second resources for retransmission are in a second LBT sub-band of the different LBT sub-bands.

14. The UE of claim 12, wherein the first sidelink communication includes a first transport block that is the same as a second transport block included in the second sidelink communication.

15. The UE of claim 12, wherein the first sidelink communication includes a first transport block that is different from a second transport block included in the second sidelink communication.

16. The UE of claim 15, wherein the one or more processors are further configured to:
selectively perform retransmission of at least one of the first sidelink communication or the second sidelink communication,
wherein the one or more processors, to selectively perform retransmission of the first sidelink communication, are configured to perform retransmission of the first sidelink communication using the one or more first resources that were indicated by the first sidelink control information, and
wherein the one or more processors, to selectively perform retransmission of the second sidelink communication, are configured to perform retransmission of the second sidelink communication using the one or more second resources that were indicated by the second sidelink control information.

17. The UE of claim 15, wherein the one or more processors are further configured to:
selectively perform retransmission of at least one of the first sidelink communication or the second sidelink communication,
wherein the one or more processors, to selectively perform retransmission of the first sidelink communication, are configured to perform retransmission of the first sidelink communication using at least one of the one or more first resources that were indicated by the first sidelink control information, or the one or more second resources that were indicated by the second sidelink control information, and
wherein the one or more processors, to selectively perform retransmission of the second sidelink communication, are configured to perform retransmission of the second sidelink communication using at least one of the one or more first resources that were indicated by the first sidelink control information, or the one or more second resources that were indicated by the second sidelink control information.

18. The UE of claim 1, wherein the one or more processors are further configured to:
identify the plurality of transmission opportunities based at least in part on a mode 2 sidelink resource selection process.

19. A method of wireless communication performed by a user equipment (UE), comprising:
performing listen-before-talk (LBT) for a plurality of transmission opportunities that are associated with different LBT sub-bands and that share a slot; and
transmitting at least one sidelink communication using at least one of the plurality of transmission opportunities based at least in part on a result of performing the LBT.

20. The method of claim 19, wherein the result of performing the LBT indicates that only one available transmission opportunity from the plurality of transmission opportunities; and
wherein transmitting the sidelink communication comprises:
transmitting the sidelink communication using the one available transmission opportunity.

21. The method of claim 19, wherein the result of performing the LBT indicates multiple available transmission opportunities from the plurality of transmission opportunities.

22. The method of claim 21, wherein transmitting the sidelink communication comprises:
transmitting the sidelink communication using all of the multiple available transmission opportunities.

23. The method of claim 21, wherein transmitting the sidelink communication comprises:
transmitting the sidelink communication using a single transmission opportunity of the multiple available transmission opportunities.

24. The method of claim 23, further comprising:
identifying, from the multiple available transmission opportunities, the single transmission opportunity by random selection.

25. The method of claim 23, further comprising:
identifying, from the multiple available transmission opportunities, the single transmission opportunity based at least in part on a preconfigured indication of a primary transmission opportunity.

26. The method of claim 23, further comprising:
identifying, from the multiple available transmission opportunities, the single transmission opportunity based at least in part on measures of priority associated with the multiple available transmission opportunities.

27. The method of claim 26, wherein the measures of priority are based at least in part on one or more of:
one or more measures of energy detected when performing the LBT, or
one or more received signal strength indicator measurements obtained during resource sensing.

28. The method of claim 19, wherein transmitting the at least one sidelink communication using at least one of the plurality of transmission opportunities comprises:
transmitting a single sidelink communication using a single transmission opportunity,
wherein sidelink control information included in the single sidelink communication indicates one or more resources for retransmission of the single sidelink communication.

29. A non-transitory computer-readable medium storing a set of instructions for wireless communication, the set of instructions comprising:
one or more instructions that, when executed by one or more processors of a user equipment (UE), cause the UE to:
perform listen-before-talk (LBT) for a plurality of transmission opportunities that are associated with different LBT sub-bands and that share a slot; and
transmit at least one sidelink communication using at least one of the plurality of transmission opportunities based at least in part on a result of performing the LBT.

30. An apparatus for wireless communication, comprising:
means for performing listen-before-talk (LBT) for a plurality of transmission opportunities that are associated with different LBT sub-bands and that share a slot; and
means for transmitting at least one sidelink communication using at least one of the plurality of transmission opportunities based at least in part on a result of performing the LBT.
